(19) United States
(12) Patent Application Publication
(10) Pub. No.: US 2021/0325716 A1
(43) Pub. Date: Oct. 21, 2021

(54) Active Matrix of Cholesteric Liquid Crystal Display and Method Thereof

(71) Applicant: Sole Optoelectronics Co., Ltd., New Taipei City (TW)

(72) Inventors: Tzu-Chieh Lai, Hsinchu County (TW); Chun-Hung Huang, Hsinchu County (TW); Shui-Chih Lien, Hsinchu City (TW)

(21) Appl. No.: 16/999,079

(22) Filed: Aug. 21, 2020

(30) Foreign Application Priority Data
Apr. 21, 2020 (TW) 109113376

(51) Int. Cl. G02F 1/137; G09G 3/36

(52) U.S. Cl. CPC G02F 1/13718; G09G 3/3688; G02F 2201/343; G09G 2310/062; G09G 3/3677

(57) ABSTRACT

The present invention provides a driving method applied to the CH-LCD active matrix, which uses a plurality of gates or drains to control a single CH-LCD pixel unit, respectively controls the CH-LCD pixel unit in the resetting stage and the determining stage to increase a charging time for the CH-LCD pixel unit. Besides, the method further divides the plurality of scan lines and data lines into a plurality of groups to control each group of CH-LCD pixel units at the same time. Therefore, the charging time for the CH-LCD pixel unit may be increased for a fixed frame rate and a fixed resolution.

### BACKGROUND OF THE INVENTION

### 1. Field of the Invention

The present invention relates to an active matrix of a cholesteric liquid crystal display and driving method, and more particularly, to an active matrix of a cholesteric liquid crystal display and driving method capable of simultaneously resetting pixels and determining the reflectivity thereof.

### 2. Description of the Prior Art

The cholesteric liquid crystal reflects the light of different wavelengths by adjusting the cholesteric liquid crystal pitch and has bistable characteristics. Moreover, an active matrix of the cholesteric liquid crystal display may change a state of the cholesteric liquid crystal via voltage modulation. For example, the cholesteric liquid crystal in the planar state reflects lights of a specific wavelength, while the cholesteric liquid crystal in the focal-conic state scatters lights. Therefore, the voltage may be used to adjust the reflectivity. When adjusting the cholesteric liquid crystal state, the cholesteric liquid crystal is driven to a homeotropic state by a resetting voltage during a resetting period; and the cholesteric liquid crystal is further be driven by a determining voltage during a determining period, to convert the state of the cholesteric liquid crystal to the planar or the focal-conic state, so as to adjust the required reflectivity. Therefore, a full-color reflective display with bistable characteristics may be obtained.

However, for each pixel of the cholesteric liquid crystal display during the resetting stage, the cholesteric liquid crystal must maintain a resetting transition period to allow the cholesteric liquid crystal to adjust arrangement. On the other hand, the cholesteric liquid crystal must also keep a determining transition period during the determining stage. Therefore, a frame may be obtained once all pixels of the cholesteric liquid crystal display are reset and determined. In other words, when the resolution is higher, i.e., more pixels on the display, in order to ensure that the thin film transistors have enough time to charge the cholesteric liquid crystal display pixel units to the required voltage, a longer scan period is needed, which lowers the frame rate. On the contrary, when a specific frame rate is chosen, the total number of pixels on the display will be limited, such that the resolution of the panel may not be raised.

Therefore, it is necessary to improve the prior art.

### SUMMARY OF THE INVENTION

It is therefore a primary objective of the present invention to provide a cholesteric liquid crystal display and driving method, to improve over disadvantages of the prior art.

An embodiment of the present invention discloses a driving method, applied to a cholesteric liquid crystal display (CH-LCD) active matrix, the CH-LCD active matrix comprising a plurality of CH-LCD pixel units, the driving method comprises providing a control signal and a data signal to a CH-LCD pixel unit of the plurality of CH-LCD pixel units during a determining period, to determine a reflectivity of the CH-LCD pixel unit; and cutting off the control signal and the data signal to keep a state of the CH-LCD pixel unit for at least one determining transition period.

An embodiment of the present invention further discloses a cholesteric liquid crystal display (CH-LCD) active matrix, comprises a base plate; a plurality of CH-LCD pixel units, disposed on the base plate; a driving chip, disposed on the base plate, configured to drive the plurality of CH-LCD pixel units; wherein the driving chip provides a control signal and a data signal to a CH-LCD pixel unit of the plurality of CH-LCD pixel units during a determining period, to determine a reflectivity of the CH-LCD pixel unit; and the driving chip cuts off the control signal and the data signal, to keep a state of the CH-LCD pixel unit for at least one determining transition period.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a one-gate-one-drain CH-LCD active matrix in the prior art.

FIG. 2 is a schematic diagram of a reflectivity-voltage relationship of a cholesteric liquid crystal in the prior art.

FIG. 3 is a schematic diagram of a one-gate-one-drain CH-LCD active matrix in the prior art.

FIG. 4 is a schematic diagram of a driving method for a CH-LCD active matrix in the prior art.

FIG. 5 is a circuitry diagram of a two-gate-two-drain CH-LCD active matrix according to an embodiment of the present invention.

FIG. 6 is a schematic diagram of a driving method for a two-gate-two-drain CH-LCD active matrix according to an embodiment of the present invention.

FIG. 7 is a schematic diagram of a driving method for a CH-LCD active matrix according to an embodiment of the present invention.

FIG. 8 is a circuitry diagram of a driving circuit for a CH-LCD active matrix according to an embodiment of the present invention.

FIG. 9 is a schematic diagram of a driving method for a CH-LCD active matrix according to an embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and the claims, the terms “include” and “comprise” are used in an open-ended fashion, and thus should be interpreted to mean “include, but not limited to . . . ”. “Roughly” means that within an acceptable error range, and those skilled in the art may solve the technical problem within a certain error range, and basically achieve the technical effect. Also, the term “couple” is intended to mean either an indirect or direct electrical connection. Accordingly, if one device is electrically connected to another device, that connection may be through a direct electrical connection or through an indirect electrical connection via other devices and connections.

In addition, although shown as different circuits for purpose of explanation, a circuit may be implemented as separate circuits, partially or wholly integrated as the same circuit. In other words, if the system may comprise a first circuit, a second circuit, and a third circuit, then a part or whole of any of the first, second and third circuits may be integrated with or separated with a part or whole of any other(s) of the first, second and third circuits.

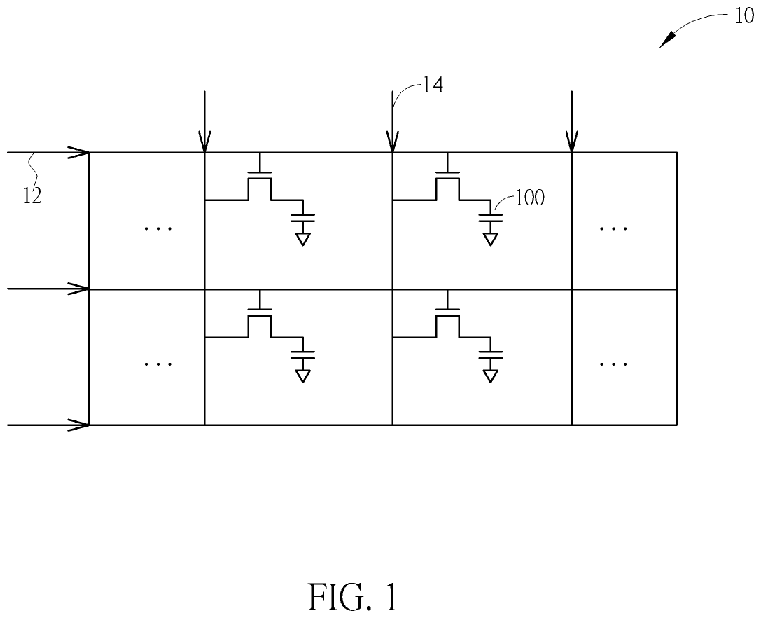

FIG. 1 is a schematic diagram of a one-gate-one-drain (1G1D) thin film transistor liquid crystal display (TFT-LCD) active matrix 10 in the prior art. As shown in FIG. 1, the matrix-type liquid crystal display (LCD) technique utilizes a scan line 12 corresponding to a data line 14 to drive a TFT-LCD pixel unit 100. Moreover, in a horizontal scan line 12, all gates of the LCD pixel units are coupled to the same scan line; hence, when a voltage is applied, these TFTs operate jointly. In other words, if a large enough voltage is applied to a scan line 12 to have the gate voltage larger than the common source voltage by a threshold, then all of TFTs in the scan line will be turned on. In this situation, when a TFT is turned on, a corresponding TFT-LCD pixel unit in the scan line 12 may be coupled to the vertical data line 14, such that a corresponding video signal charges the TFT-LCD pixel unit to a desired voltage level via the data line 14. This action controls the grayscale and brightness of each TFT-LCD pixel unit 100.

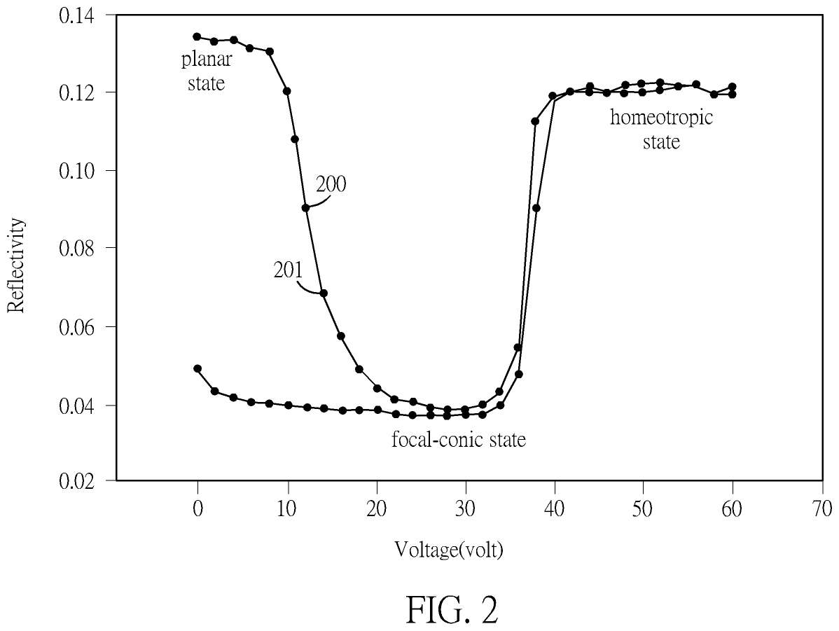

FIG. 2 is a schematic diagram of a reflectivity-voltage relationship of a cholesteric liquid crystal in a cholesteric liquid crystal display (CH-LCD) in the prior art. As shown in FIG. 2, the state of the cholesteric liquid crystal may be changed in response to the applied voltage. For example, the cholesteric liquid crystal in the planar state reflects lights of a specific wavelength, while the cholesteric liquid crystal in the focal-conic state scatters lights. Therefore, the voltage may be used to adjust the reflectivity. When adjusting the cholesteric liquid crystal state, the cholesteric liquid crystal may be driven to the homeotropic state by a resetting voltage during a resetting period, and the cholesteric liquid crystal may further be driven by a determining voltage during a determining period, to convert the state of the cholesteric liquid crystal to the planar or the focal-conic state, so as to adjust the required reflectivity. Therefore, a full-color reflective display with bistable characteristics may be obtained. Finally, the plurality of full-color reflective CH-LCD pixel units are arranged to implement a full-color reflective CH-LCD active matrix.

Notably, the change of the reflectivity is corresponding to the change of the periodic spiral structure of the cholesteric liquid crystal. When the wavelength of the incident light and the gap of the cholesteric liquid crystal meet Bragg conditions (i.e., 2d sin θ=nλ), the intense reflected light may be obtained, wherein d is the interplanar distance within the cholesteric liquid crystal, θ is the glancing angle, n is a positive integer corresponding to the cholesteric liquid crystal, and λ is the wavelength of the incident wave. Therefore, the CH-LCD may control the cholesteric liquid crystal arrangement to adjust the reflectivity. In addition, the Bragg reflection reflects the light similar to the material structure, so that if the cholesteric liquid crystal is in a levorotation structure, it reflects the levorotation light; otherwise, if the cholesteric liquid crystal molecular is in a dextrorotation structure, it reflects the dextrorotation light.

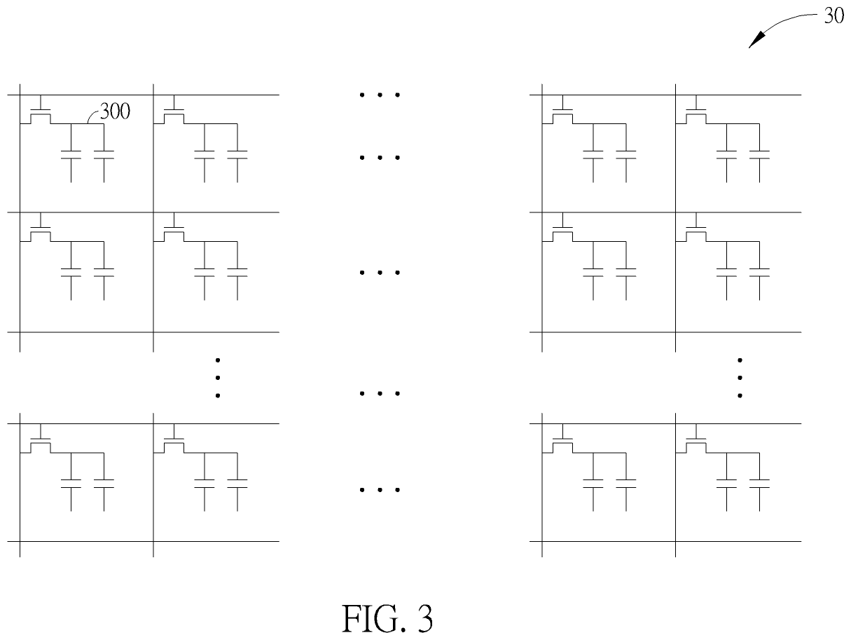

In practical applications, the system is not only implemented with a single cholesteric liquid crystal. FIG. 3 is a schematic diagram of a 1G1D CH-LCD active matrix 30 in the prior art. As shown in FIG. 3, the structure of the CH-LCD active matrix 30 is roughly the same as that of the TFT-LCD active matrix 10. The difference is that the TFT-LCD pixel units 100 in the TFT-LCD active matrix 10 are replaced with CH-LCD pixel units 300. Besides, the functions of the remaining components in the CH-LCD active matrix 30 are the same as those in FIG. 1, which are not narrated herein for brevity.

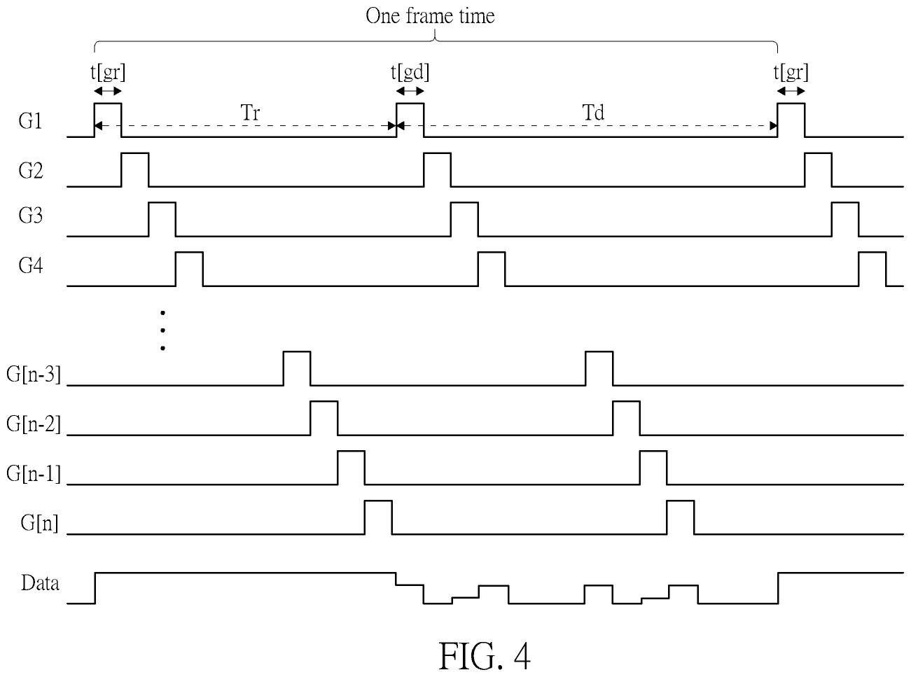

The structures between the CH-LCD active matrix 30 and the TFT-LCD active matrix 10 are roughly the same; however, as illustrated in FIG. 2, the CH-LCD active matrix 30 must reset each of the CH-LCD pixel units and adjust the CH-LCD pixel units to the desired reflectivity. Accordingly, the driving method of the CH-LCD active matrix 30 is illustrated in FIG. 4. In addition, as can be seen in FIG. 4, the resetting transition period is Tr, and the determining transition period is Td for the cholesteric liquid crystal.

More specifically, the CH-LCD pixel unit may change from the focal-conic state or the planar state to the homeotropic state due to a control signal and a data signal during the resetting transition period Tr. The CH-LCD pixel unit may also change from the homeotropic state to the focal-conic state or the planar state due to another control signal and another data signal during the determining transition period Td. Therefore, the CH-LCD active matrix 30 may adjust the reflectivity of each of the CH-LCD pixel units pixel-by-pixel.

Notably, based on the characteristics of the cholesteric liquid crystal, the required voltage during the resetting transition period may not be the same as the required voltage during the determining transition period. For example, the cholesteric liquid crystal is necessary to have a potential difference of about 35 volts between two terminals during the resetting transition period, while the cholesteric liquid crystal is necessary to have a potential difference of about 20 volts during the determining transition period. Therefore, the gate voltage and the drain voltage are needed to be appropriately adjusted or controlled at different stages, such that the cholesteric liquid crystal is subjected to an electric field strength that meets the requirement.

On the other hand, the resetting transition period Tr and the determining transition period Td of the CH-LCD pixel unit are longer (in an embodiment of a 60 Hz frame-rate CH-LCD, whose resetting transition period Tr and determining transition period Td are respectively configured to be 2 milliseconds and 14 milliseconds.) However, the time for the CH-LCD pixel unit to receive a control signal may be very short. For example, as shown in FIG.4, the time for the CH-LCD pixel unit to receive a control signal in the resetting stage (i.e., a resetting period) t[gr] and the time to receive a control signal in the determining stage (i.e., the determining period) t[gd] are respectively microseconds and ten microseconds levels. Take the resetting stage as an example, the CH-LCD pixel unit receives a control signal in a resetting period, cuts off the control signal to isolate from other control signals, and keeps cholesteric liquid crystal for a resetting transition period to change to the homeotropic state. In the meantime, when the CH-LCD pixel unit keeps within the resetting transition period, the driving chip may continue to provide another control signal and another data signal to another CH-LCD pixel unit, to reset another CH-LCD pixel unit. On the other hand, except that lengths of the determining period and the determining transition period in the determining stage are different from lengths in the resetting stage, the operating principle and methods are similar, which are not narrated herein for brevity.

Therefore, as shown in FIG. 4, if a 1G1D driving method is applied, after all the scan lines G[1]-G[N] are turned on to determine, all the CH-LCD pixel units must be reset, and then the scan lines G[1]-G[N] may be turned on again. Thus, the time of the CH-LCD pixel units in different rows respectively receiving the resetting-stage control signal and receiving the determining-stage control signal must not overlap. Otherwise, the same vertical data signal will be inputted to the CH-LCD pixel units on different rows at the same time, such that the CH-LCD pixel units cannot be completely reset or correctly transformed to the desired reflectivity.

On the contrary, the charging time t[gr] and t[gd] of the CH-LCD pixel units in the prior art are limited since the time for receiving the resetting-stage control signal and the time for receiving the determining-stage control signal cannot overlap. For example, suppose the frame rate is 60 Hz, there are 1280×768 CH-LCD pixel units in the CH-LCD active matrix 30, and the resetting transition period Tr and the determining transition period Td are set to be 2 milliseconds and 14 milliseconds, respectively. Without considering the cholesteric liquid crystal transition period, the time for each scan line to receive the resetting-stage control signal and the determining-stage control signal are merely 2.6 microseconds ( 2/768 milliseconds) and 18.2 microseconds ( 14/768 milliseconds) to update one frame. Therefore, the charging time t[gr] and t[gd] will not be enough (especially the time t[gr] for receiving resetting-stage control signals.) In other words, if a specific frame rate is required, the total number of scan lines (which are corresponding to the number of the CH-LCD pixel units) in the CH-LCD active matrix 30 must be reduced, or the time for receiving the resetting-stage control signal and the determining-stage control signal must be shortened while completing the charging for the CH-LCD pixel units. The former will reduce the resolution of the CH-LCD active matrix 30, and the latter will increase the design complexity of the driving circuit or the CH-LCD pixel units.

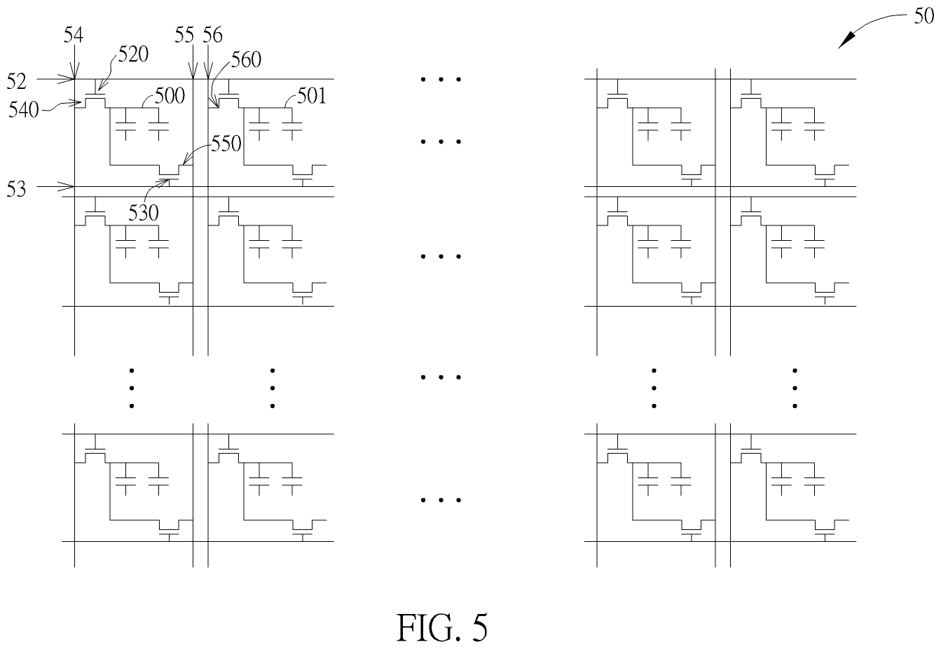

The present invention provides a CH-LCD active matrix, which may respectively control a plurality of gates coupled to the scan lines and a plurality of drains coupled to the data lines of each of the CH-LCD pixel units, such that the plurality of gates and the plurality of drains may be respectively controlled. For example, FIG. 5 is a circuitry diagram of a two-gate-two-drain (2G2D) CH-LCD active matrix 50 according to an embodiment of the present invention. In FIG. 5, gates 520 and 530 of a CH-LCD pixel unit 500 in the 2G2D CH-LCD active matrix 50 may be coupled to scan lines 52 and 53, and drains 540 and 550 may be coupled to data lines 54 and 55 to be respectively controlled.

In an embodiment, during the resetting stage, the control signal is received via the gate 520, so as to transmit the data signal to the drain 540, to reset the CH-LCD pixel unit 500; on the other hand, during the determining stage, the control signal is received via the gate 530, so as to transmit the data signal to the drain 550, to determine the reflectivity of the CH-LCD pixel unit 500. Since the scan line and the data line are corresponding to different transistor switching elements in the resetting stage and the determining stage, the data signal in the determining stage would not transmit to the CH-LCD pixel unit in the resetting stage, and vice versa.

As mention above, based on the characteristics of cholesteric liquid crystals, the required voltage during the reset stage is not the same as the required voltage during the determining stage. Therefore, if paths of the control signal and the data signal are separated on the circuit, the design complexity of the circuit may be simplified.

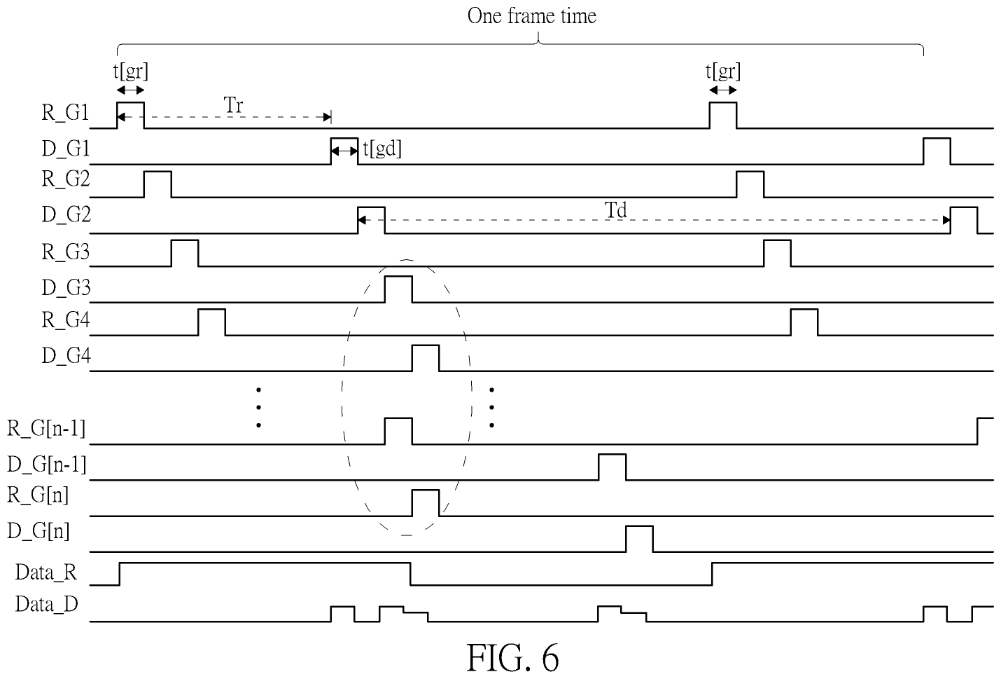

Furthermore, FIG. 6 is a schematic diagram of a driving method for the 2G2D CH-LCD active matrix 50 according to an embodiment of the present invention. In FIG. 6, R_G[N] denotes a signal in an N-th row scan line of CH-LCD pixel units during the resetting stage, D_G[N] denotes a signal in an N-th row scan line of CH-LCD pixel units during the determining stage, Data_R denotes a signal in data line of CH-LCD pixel units during the resetting stage, Data_D denotes a signal in data line of CH-LCD pixel units during the determining stage. Firstly, the scan lines R_G[1]-R_G[N] are sequentially turned on (R_G[1], R_G[2], . . . , R_G[N]) during the resetting stage and receive the resetting-stage data signal Data_R at a time t[gr] of the resetting-stage control signal during the resetting stage, and keep the cholesteric liquid crystal for a resetting transition period to change to the homeotropic state. Then, the scan lines D G[1]-D G[N] are sequentially turned on (D_G[1], D_G[2], . . . , D_G[N]) and receive the determining-stage data signal Data_D at a time t[gd] of the determining-stage control signal during the determining stage, and keep cholesteric liquid crystal for a determining transition period to change to the focal-conic or the planar state, to adjust each reflectivity of the CH-LCD pixel units of the CH-LCD active matrix pixel by pixel. Besides, because the scan lines and the data lines are corresponding to different circuits in the resetting stage and the determining stage, the data signal during the determining stage would not be transmitted to the CH-LCD pixel units under the resetting stage. Thus, except that the resetting R_G[N] and the determining D_G[N] scan line in the same row cannot be turned on simultaneously, the time t[gr] and t[gd] of CH-LCD pixel units in the different rows may separately and simultaneously receive the resetting-stage control signal and the determining-stage control signal, as shown by a dotted line in FIG. 6, where when the third row scan line D_G[3] is turned on during the determining stage, the time t[gd] to receive the determining-stage control signal may be overlapped with the time t[gr] of the N-1 row to receive the resetting-stage control signal. Suppose that the number of the CH-LCD pixel units is 1280×768 in the CH-LCD active matrix 50 of 60 Hz frame rate, and the resetting transition period Tr and the determining transition period Td are set to be 2 milliseconds and 14 milliseconds, respectively. The present invention may turn on scan lines G[1]-G[N] and does not need to wait until all scan lines G[1]-G[N] are turned on to reset CH-LCD pixel units. In the meantime, the time t[gr] and t[gd] for each scan line to receive the resetting-stage control signal and the determining-stage control signal are at most 2 microseconds ( 2/768 milliseconds) and 18.2 microseconds ( 14/768 milliseconds), to determine one frame update. Therefore, the charging time t[gr] may be increased to reduce the design difficulty in the CH-LCD pixel unit circuit.

Therefore, the CH-LCD active matrix 50 shown in FIG. 5 may determine a row of the CH-LCD pixel units and simultaneously reset another row of the CH-LCD pixel units. In other words, as long as the order for resetting and determining each CH-LCD pixel unit in the CH-LCD active matrix 50 is well arranged, the resetting period t[gr] and the determining period t[gd] may be increased or adjusted while maintaining the same resetting transition period Tr and determining transition period Td, to ensure that the time for the CH-LCD pixel unit to be charged to a required voltage level is enough.

On the other hand, the present invention may divide the scan lines and data lines of the CH-LCD active matrix into a plurality of groups, to simultaneously or respectively control the CH-LCD pixel units, wherein the scan method for each of the CH-LCD pixel units in each CH-LCD subgroup or submatrix may be in a sequential, random or any other orders. The order for controlling and the corresponding circuit are known to those skilled in the art, which are not narrated herein for brevity.

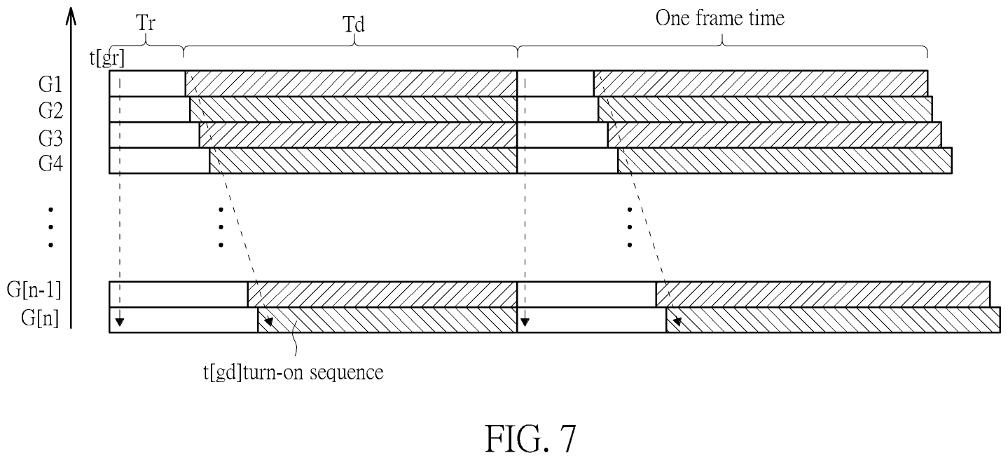

FIG. 7 is a schematic diagram of a driving method for a CH-LCD active matrix according to an embodiment of the present invention. Because the plurality of CH-LCD pixel units may reset at the same time, the reflectivity of each CH-LCD pixel unit may be separately determined. Therefore, the plurality of CH-LCD pixel units may be driven by the driving method shown in FIG. 7 to reset at the same time, so as to increase or adjust the resetting period t[gr] and the determining period t[gd] of each scan line while keeping the same resetting transition period Tr and the determining transition period Td, to ensure that the time for the CH-LCD pixel unit to be charged to a required voltage level is enough. Notably, because the scan lines that determine the reflectivity of each CH-LCD pixel unit are turned on in sequence, the time Tr and Td may be different between rows of CH-LCD pixel units even if the time Tr+Td of each row of CH-LCD pixel units are the same,; that is, the time Tr and Td of the first row differ from the time Tr and Td of another row. In other words, the larger Tr leads to the smaller Td to keep the time Tr+Td of each row of CH-LCD pixel units to be the same; thus, the time difference of Tr and Td between the first row and the last row would be large when the resolution is increasing.

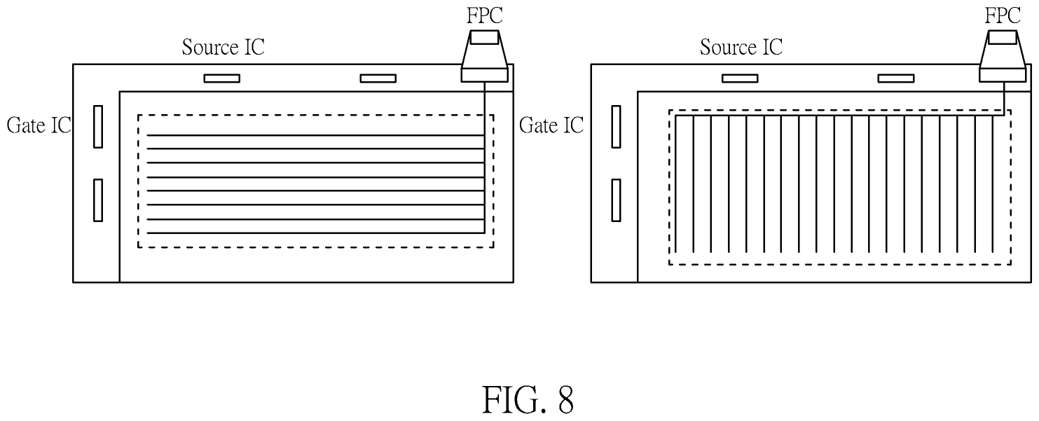

Besides, FIG. 8 is a circuitry diagram of a driving circuit for a CH-LCD active matrix according to an embodiment of the present invention. If the plurality of CH-LCD pixel units are reset at the same time, as illustrated in FIG.7, the scan lines for resetting may be regarded as a group coupled together to simplify the circuit and reduce the complexity of routing.

Notably, the embodiments stated in the above are utilized for illustrating the concept of the present invention. For example, the number of gates and drains of the CH-LCD active matrix may be 3, 4, or more. On the other hand, the driving method is not limited to increasing the number of scan lines and data lines simultaneously. For example, as shown in FIG. 8, a scan line and a data line respectively transmit the control signal and the data signal to the CH-LCD pixel unit to reset the CH-LCD pixel unit. Alternatively, scan lines of the CH-LCD are not directly connected and only the same signal is inputted to keep the flexibility of utilization.

For example, in an embodiment, each unit of the two-gate-two-grain CH-LCD active matrix 50 may be implemented by an application-specific integrated circuit (ASIC). In an embodiment, the driving chip may be an application processor (AP) or a digital signal processor (DSP), wherein the processing unit 400 may be a central processing unit (CPU), a graphics processing unit (GPU) or a tensor processing unit (TPU) to provide the driving signal mention above, and not limited thereto.

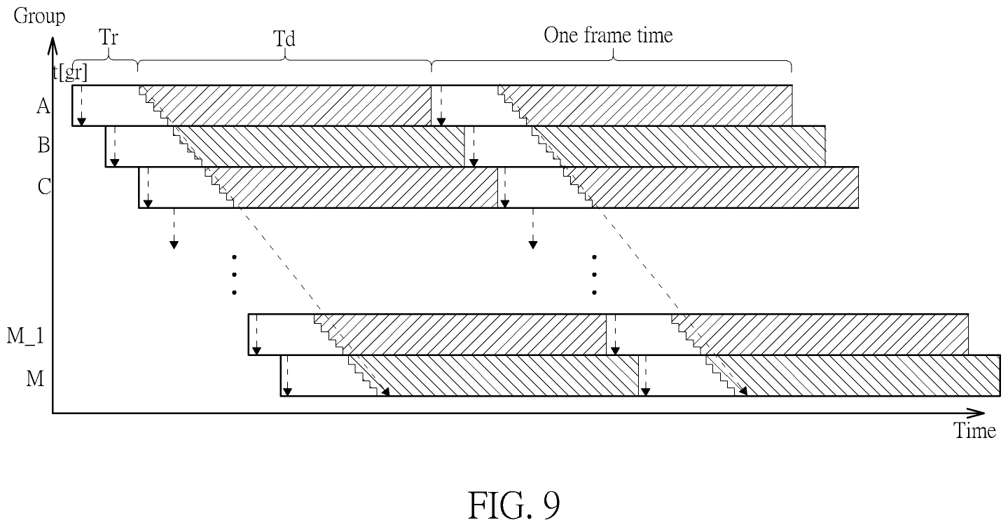

Combining the embodiments mentioned above, FIG. 9 is a schematic diagram of a driving method for a CH-LCD active matrix according to an embodiment of the present invention. In an embodiment, a plurality of scan lines may be divided into M groups, the CH-LCD pixel units in the same group may be reset by a same control signal at a same time and then be sequentially determined. The embodiment may improve the embodiment shown in FIG.7 that the time difference of Tr and Td between the first row and the last row is large when the resolution is increasing. The resetting period Tr and the determining period Td of the CH-LCD pixel units in the different groups are the same, and the resetting period Tr and the determining period Td of the CH-LCD pixel units in the same group are different (yet the time of Tr+Td is the same), therefore. However, the time difference of Tr and Td between the first row and the last row in the same group still exists, the time difference will be decreased when the number of groups increases (i.e., the number of rows for each group decreases). Besides, the time difference of Tr and Td between the first row and the last row may be the same for different groups. That is, the issue of the time difference of Tr and Td between the first row and the last row when the resolution is increasing may be released.

Although the above description relies on the horizontal scan lines and the vertical data lines for explanation, the scan lines may be vertical, and the data lines may be horizontal or other types considering the requirements of the practical scenario. The active matrix circuit design method is well known for those skilled in the art, which is not narrated herein for brevity.

The embodiments stated in the above are utilized for illustrating the concept of the present invention. Those skilled in the art may make modifications and alterations accordingly, which are not limited herein. Therefore, as long as a driving method, applied to the CH-LCD active matrix, controls the plurality of gates or drains of a single CH-LCD pixel unit, and divides the plurality of scan lines and data lines into a plurality of groups to control each group of CH-LCD pixel unit at the same time or at different times, the requirements of the present invention are satisfied and within the scope of the present invention.

In summary, the present invention provides a driving method applied to the CH-LCD active matrix, which uses a plurality of gates or drains to control a single CH-LCD pixel unit, respectively controls the CH-LCD pixel unit in the resetting stage and the determining stage to increase a charging time for the CH-LCD pixel unit. Besides, the method further divides the plurality of scan lines and data lines into a plurality of groups to control each group of CH-LCD pixel unit at the same time. Therefore, the charging time for the CH-LCD pixel unit may be increased for a fixed frame rate and a fixed resolution.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A driving method, applied to a cholesteric liquid crystal display (CH-LCD) active matrix, the CH-LCD active matrix comprising a plurality of CH-LCD pixel units, the driving method comprising:
providing a control signal and a data signal to a CH-LCD pixel unit of the plurality of CH-LCD pixel units during a determining period, to determine a reflectivity of the CH-LCD pixel unit; and
cutting off the control signal and the data signal to keep a state of the CH-LCD pixel unit for at least one determining transition period.

2. The driving method of claim 1, further comprising:
providing another control signal and another data signal to the CH-LCD pixel unit during a resetting period, to reset the CH-LCD pixel unit; and
keeping a state of the CH-LCD pixel unit for at least one resetting transition period.

3. The driving method of claim 2, wherein each of the CH-LCD pixel units comprises a plurality of gates and a plurality of drains to respectively receive the control signal and the data signal.

4. The driving method of claim 3, wherein determining periods of, resetting periods of, or the determining period and the resetting period of different CH-LCD pixel units of the plurality of CH-LCD pixel units are overlapped.

5. The driving method of claim 2, further comprising dividing the plurality of CH-LCD pixel units into a plurality of groups.

6. The driving method of claim 5, further comprising: when a CH-LCD pixel unit in a group of the plurality of groups receives the control signal during the resetting period, having gates of CH-LCD pixel units other than the CH-LCD pixel unit in the group to receive the same control signal.

7. The driving method of claim 5, further comprising: when a CH-LCD pixel unit in a group of the plurality of groups receives the control signal during the resetting period, having drains of CH-LCD pixel units other than the CH-LCD pixel unit in the group to receive the same data signal.

8. The driving method of claim 6, further comprising: when a CH-LCD pixel unit in a group of the plurality of groups receives the control signal during the resetting period, having gates of CH-LCD pixel units other than the CH-LCD pixel unit in the group to be connected in parallel to a scan line.

9. The driving method of claim 7, further comprising: when a CH-LCD pixel unit in a group of the plurality of groups receives the control signal during the resetting period, having drains of CH-LCD pixel units other than the CH-LCD pixel unit in the group to be connected in parallel to a data line.

10. A cholesteric liquid crystal display (CH-LCD) active matrix, comprising:
a base plate;
a plurality of CH-LCD pixel units, disposed on the base plate;
a driving chip, disposed on the base plate, configured to drive the plurality of CH-LCD pixel units;
wherein the driving chip provides a control signal and a data signal to a CH-LCD pixel unit of the plurality of CH-LCD pixel units during a determining period, to determine a reflectivity of the CH-LCD pixel unit; and
the driving chip cuts off the control signal and the data signal, to keep a state of the CH-LCD pixel unit for at least one determining transition period.

11. The CH-LCD active matrix of claim 10, wherein:
the driving chip provides another control signal and another data signal to the CH-LCD pixel unit during a resetting period, to reset the CH-LCD pixel unit; and
the driving chip keeps a state of the CH-LCD pixel unit for at least one resetting transition period.

12. The CH-LCD active matrix of claim 11, wherein each of the CH-LCD pixel units comprises a plurality of gates and a plurality of drains to respectively receive the control signal and the data signal.

13. The CH-LCD active matrix of claim 12, wherein determining periods of, resetting periods of, or the determining period and the resetting period of different CH-LCD pixel units of the plurality of CH-LCD pixel units are overlapped.

14. The CH-LCD active matrix of claim 11, wherein the driving chip further divides the plurality of CH-LCD pixel units into a plurality of groups.

15. The CH-LCD active matrix of claim 14, wherein when a CH-LCD pixel unit in a group of the plurality of groups receives the control signal during the resetting period, gates of CH-LCD pixel units other than the CH-LCD pixel unit in the group receive the same control signal.

16. The CH-LCD active matrix of claim 14, wherein when a CH-LCD pixel unit in a group of the plurality of groups receives the control signal during the resetting period, drains of CH-LCD pixel units other than the CH-LCD pixel unit in the group receive the same data signal.

17. The CH-LCD active matrix of claim 15, wherein when a CH-LCD pixel unit in a group of the plurality of groups receives the control signal during the resetting period, gates of CH-LCD pixel units other than the CH-LCD pixel unit in the group are connected in parallel to a scan line.

18. The CH-LCD active matrix of claim 16, wherein when a CH-LCD pixel unit in a group of the plurality of groups receives the control signal during the resetting period, drains of CH-LCD pixel units other than the CH-LCD pixel unit in the group are connected in parallel to a data line.
